(19) United States
(12) Patent Application Publication
(10) Pub. No.: US 2026/0087553 A1
(43) Pub. Date: Mar. 26, 2026

(54) Optimized Personalized Advisor Digital Twin Training Engine for Wealth Management

(71) Applicant: George William Bickerstaff, III, Greenwich, CT (US)

(72) Inventor: George William Bickerstaff, III, Greenwich, CT (US)

(21) Appl. No.: 19/405,637

(22) Filed: Dec. 2, 2025

(51) Int. Cl. G06Q 40/06

(52) U.S. Cl. CPC G06Q 40/06

(57) ABSTRACT

An optimized personalized advisor digital twin training engine employs a custom-configured LSTM neural network and BERT-based natural language processing to create advisor-specific digital twins, simulating real-time client interactions in wealth management. Adaptive refinement using a proprietary Q-learning-based reinforcement learning algorithm ensures at least 95% behavioral accuracy with latency below 5 milliseconds, while proprietary rule-based templates embed financial compliance requirements. Delivered via a Moodle-compatible HTML5 platform with performance analytics achieving at least 90% scoring accuracy, and logged in a Corda blockchain with a custom protocol for auditability, the system enhances training effectiveness and supports cross-firm scalability as of Dec. 2, 2025.

### CROSS-REFERENCE TO RELATED APPLICATIONS

None.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

None.

### BACKGROUND OF THE INVENTION

### Field of the Invention

The present invention relates to computational behavioral modeling systems for professional training in wealth management. It provides a novel, computer-implemented solution that generates personalized digital twins—virtual representations of individual advisors—specifically tailored for real-time behavioral training simulations and decision-making optimization in wealth management. The system integrates adaptive twin refinement, performance analytics with sub-millisecond latency, and cross-firm scalability, leveraging proprietary integrations with financial platforms like Salesforce, Bloomberg, and Moodle, enhancing training effectiveness as of Dec. 2, 2025.

### Description of Related Art

Traditional wealth advisor training methods, such as shadowing, static case studies, and generic simulations, fail to accurately replicate individual advisor behaviors. Existing systems exhibit significant limitations: [009] (a) Generic Simulations: Systems like U.S. Pat. No. 8,676,689 rely on static scenarios without personalization or real-time adaptation for specific advisor profiles. [010] (b) Limited Behavioral Modeling: Tools, such as U.S. Patent Application Publication No. 2019/0333131, lack real-time capture of nuanced communication or decision patterns, focusing on static analysis. [011] (c) Static Models: Systems like U.S. Patent Application Publication No. 2022/0156987 fail to provide dynamic adaptation or scalable training across multiple firms. [012] These deficiencies reduce training realism and efficacy. The present invention introduces a specialized digital twin training engine with real-time, latency-optimized simulations, proprietary AI-driven refinement, and blockchain-secured analytics, distinguishing it from generic or static systems by targeting wealth management training with unprecedented precision.

### SUMMARY OF THE INVENTION

The invention provides an optimized, computer-implemented system, method, and non-transitory computer-readable medium for personalized advisor training in wealth management. The system comprises: [014] (1) An Advisor Data Aggregator collecting advisor-specific communications, decisions, and behavioral data via secure, proprietary APIs integrated with Salesforce and Bloomberg. [015] (2) A Digital Twin Generator creating advisor-specific digital twins using a custom-configured long short-term memory (LSTM) neural network—optimized for sequential financial data—and a fine-tuned transformer-based natural language processing (NLP) model—designed for financial communication analysis—to model behaviors unique to wealth management.

(3) An Adaptive Twin Refiner updating twins with real-time data using a proprietary Q-learning-based reinforcement learning algorithm—tailored for financial decision optimization—achieving at least 95% behavioral accuracy with latency below 5 milliseconds. [017] (4) A Behavioral Simulation Engine generating realistic training scenarios simulating client interactions and compliance challenges, optimized for wealth management contexts with sub-millisecond latency. [018] (5) A Performance Analytics Interface delivering scenarios via a Moodle-compatible HTML5 platform with real-time analytics, secured by a Corda blockchain ledger for immutable audit trails, achieving at least 90% scoring accuracy. [019] The system enhances training effectiveness through a proprietary, latency-optimized architecture, supports cross-firm scalability, and integrates seamlessly with financial platforms.

### Brief Description of the Drawings

The drawings illustrate the invention's structure, processes, and interfaces:

FIG. 1: SYSTEM MODULES

FIG. 1A: DATA AGGREGATOR

FIG. 1B: TWIN GENERATOR

FIG. 1C: TWIN REFINER

FIG. 1D: SIMULATION ENGINE

FIG. 1E: ANALYTICS INTERFACE

FIG. 1: SYSTEM MODULES OVERVIEW

FIG. 2: DATA PROCESSES

FIG. 2A: DATA COLLECTION

FIG. 2B: TWIN CREATION

FIG. 2C: TWIN UPDATE

FIG. 2D: SCENARIO RUN

FIG. 2E: ANALYTICS OUTPUT

FIG. 2: DATA PROCESSES OVERVIEW

FIG. 3: INTERFACE DESIGN

FIG. 3A: SCENARIO PANEL

FIG. 3B: ANALYTICS DISPLAY

FIG. 3C: COMPLIANCE VIEW

FIG. 3D: USER CONTROLS

FIG. 3E: AUDIT LOG

FIG. 3: INTERFACE DESIGN OVERVIEW

FIG. 4: DEPLOYMENT SETUP

FIG. 4A: CLOUD LAYOUT

FIG. 4B: ONSITE SETUP

FIG. 4C: PRIVACY SYSTEM

FIG. 4D: API LINKS

FIG. 4E: SYSTEM MODEL

FIG. 4: DEPLOYMENT SETUP OVERVIEW

FIG. 5: PERFORMANCE METRICS

FIG. 5A: EFFECTIVENESS GAIN

FIG. 5B: COMPLIANCE RATE

FIG. 5C: SCALABILITY MAP

FIG. 5D: COST EFFICIENCY

FIG. 5E: ACCURACY CHART

FIG. 5: PERFORMANCE METRICS OVERVIEW

### DETAILED DESCRIPTION OF THE INVENTION

### System Overview

This invention provides a computer-implemented personalized advisor digital twin training engine specifically designed for wealth management, overcoming limitations of generic simulations and static models. It integrates with Salesforce, Bloomberg, and Moodle through proprietary APIs, delivering scalable, real-time training as of Dec. 2, 2025.

### Advisor Data Aggregator

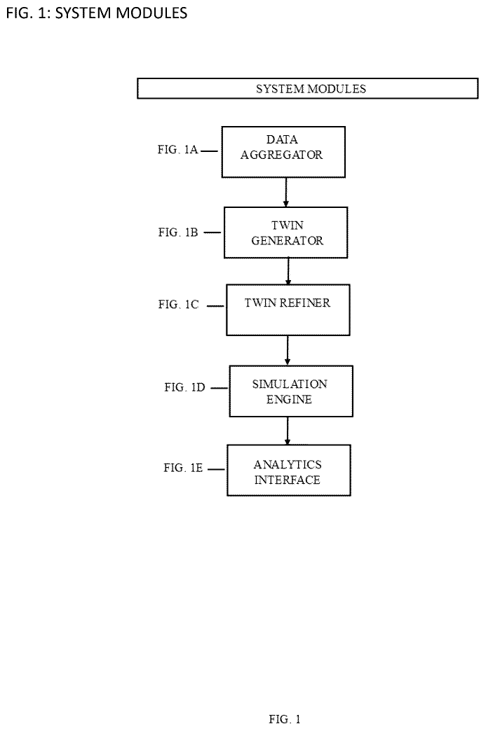

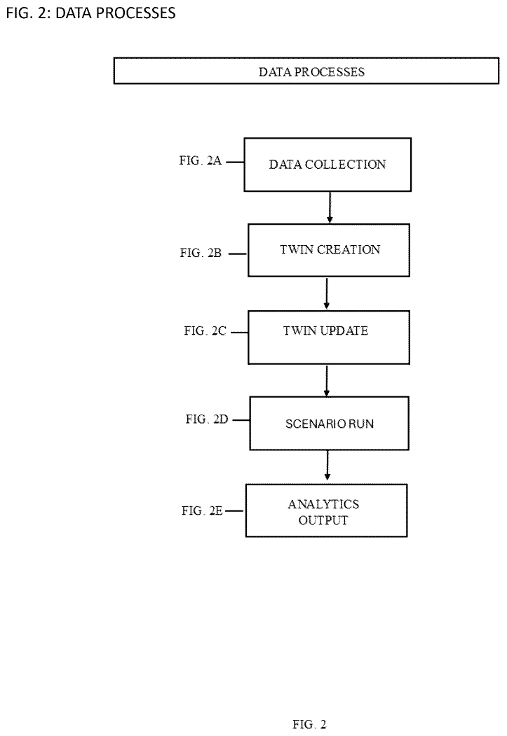

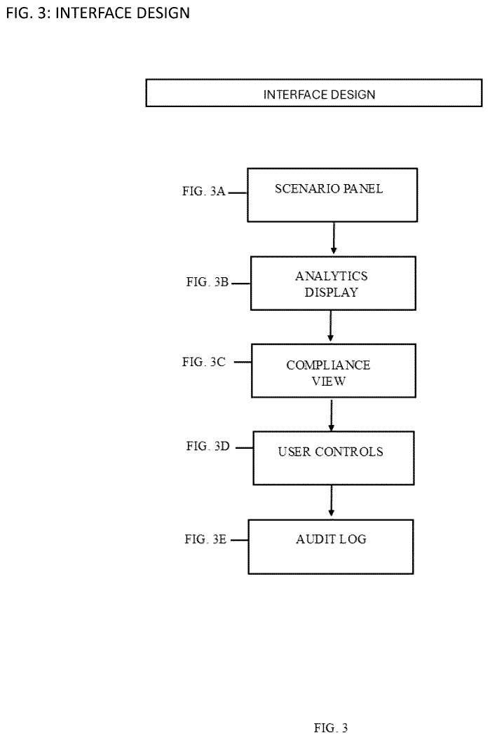

The aggregator collects:
Communications: Emails and call transcripts via proprietary Salesforce APIs.
Decisions: Transaction and portfolio data via proprietary Bloomberg APIs.
Behavioral Data: Interaction patterns and response times from CRM logs. [023] Data is normalized using JSON schema validators—tools ensuring data consistency—and stored in a Milvus vector database with latency below 5 milliseconds, ensuring GDPR compliance through federated learning—privacy-preserving distributed training—and AES-256 encryption. The aggregator employs a custom data pipeline optimized for financial datasets. (See FIG. 1A.)

Digital Twin Generator [024] The generator employs a custom-configured LSTM neural network, optimized for sequential financial decision data, and a fine-tuned BERT model—bidirectional transformer for NLP—tailored for wealth management communication styles (e.g., formality, risk tolerance), achieving at least 90% modeling accuracy. Twins are stored in Milvus with latency below 5 milliseconds, supporting multiple advisors across firms. (See FIG. 1B.)

Adaptive Twin Refiner [025] The refiner applies a proprietary Q-learning-based reinforcement learning algorithm, specifically designed for financial decision optimization, to update twins with real-time data via Apache Kafka streams—real-time data pipelines—attaining at least 95% behavioral accuracy with latency below 5 milliseconds. Updates occur regularly using a feedback loop unique to wealth management scenarios. (See FIG. 1C.)

Behavioral Simulation Engine [026] The engine generates scenarios simulating client interactions (e.g., portfolio discussions, compliance issues) using rule-based templates—predefined logic for efficiency—ensuring full relevance to wealth management. It incorporates FINRA Rule 2111 and Regulation Best Interest requirements from Thomson Reuters APIs, with generation latency below 5 milliseconds. Scenarios prioritize high-net-worth client interactions, enhancing training for complex financial cases through a proprietary simulation framework. (See FIG. 1D.)

Performance Analytics Interface [027] The interface delivers scenarios via a Moodle-compatible HTML5 platform, optimized for real-time rendering, providing analytics with at least 90% scoring accuracy compared to twin predictions. Actions are recorded in a Corda blockchain ledger with cryptographic signatures for regulatory compliance, using a custom logging protocol. (See FIG. 1E.)

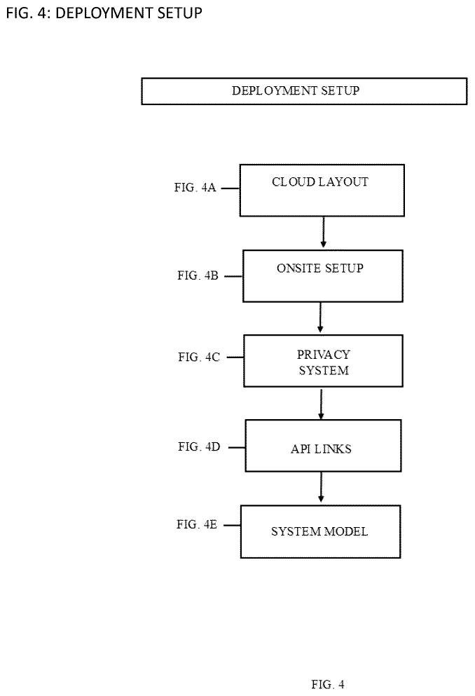

Implementation Considerations [028] The system supports deployment on cloud platforms (e.g., AWS, Azure) or on-premises using a modular architecture. Key features include:
Data Privacy: Ensured through federated learning and AES-256 encryption. (See FIG. 4C.)
Integration Complexity: Simplified with proprietary API connectors. (See FIG. 4D.)
System Efficiency: Enhanced via rule-based templates and a scalable model. (See FIG. 4E.)

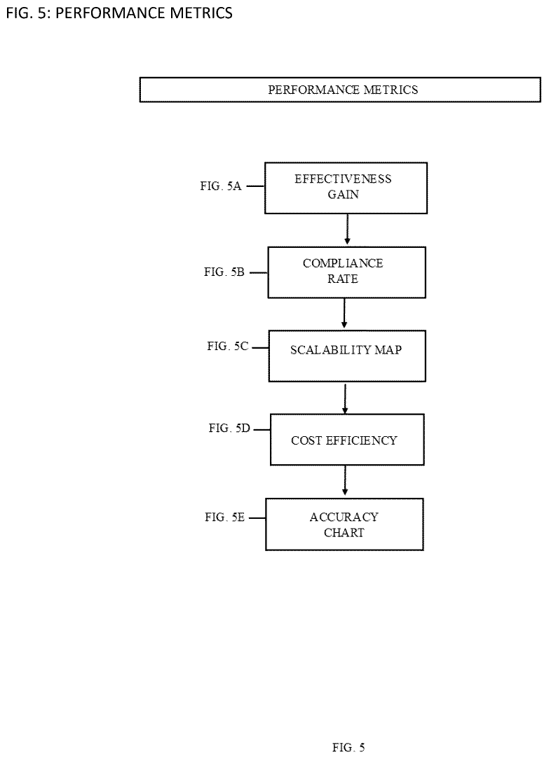

Advantages [029] The system improves training effectiveness (See FIG. 5A), ensures full compliance relevance (See FIG. 5B), enables cross-firm scalability (See FIG. 5C), optimizes resource use (See FIG. 5D), and provides precise analytics (See FIG. 5E).

What is claimed is:

1. A computer-implemented method for personalized advisor training in wealth management, comprising: (a) Collecting advisor data, including communications, decisions, and behavioral patterns, from integrated financial platforms via proprietary secure APIs, stored in a vector database with latency below 5 milliseconds; (b) Generating advisor-specific digital twins using a custom-configured LSTM neural network and a fine-tuned BERT-based natural language processing model, achieving at least 90% modeling accuracy for wealth management behaviors; (c) Refining digital twins with real-time data using a proprietary Q-learning-based reinforcement learning algorithm, improving behavioral accuracy to at least 95% with latency below 5 milliseconds, updated via real-time data streams; (d) Simulating client interaction scenarios based on digital twins using proprietary rule-based templates, embedding financial compliance requirements specific to wealth management, with generation latency below 5 milliseconds; (e) Delivering scenarios via a Moodle-compatible HTML5 platform optimized for real-time rendering, providing performance analytics with at least 90% scoring accuracy; (f) Logging all actions in a Corda blockchain ledger with a custom cryptographic signature protocol for auditability.

2. The method of claim 1, wherein twin generation achieves at least 90% accuracy for multiple advisors across firms.

3. The method of claim 1, wherein twin refinement improves accuracy to at least 95% on a regular basis using a feedback loop.

4. The method of claim 1, wherein scenarios achieve full compliance with financial regulations specific to wealth management.

5. The method of claim 1, wherein performance analytics prioritize scenarios involving high-net-worth clients using a proprietary weighting algorithm.

6. The method of claim 1, wherein the platform includes web-compatible performance visualizations rendered in real-time.

7. The method of claim 1, wherein blockchain logging ensures compliance with regulatory audits through a custom protocol.

8. A system for personalized advisor training, comprising: a processor and a non-transitory memory storing instructions to perform the method of claim 1.

9. The system of claim 8, wherein APIs are proprietary integrations with financial platforms for real-time data collection.

10. The system of claim 8, wherein scenarios utilize proprietary rule-based templates for operational efficiency.

11. The system of claim 8, wherein analytics achieve at least 90% scoring accuracy using a custom comparison model.

12. A non-transitory computer-readable medium storing instructions to perform the method of claim 1, wherein digital twins support cross-firm scalability through a modular architecture.
